(19) United States
(12) Patent Application Publication
(10) Pub. No.: US 2010/0289839 A1
(43) Pub. Date: Nov. 18, 2010

(54) LIQUID CRYSTAL DISPLAY

(76) Inventors: Woongki Min, Daegu (KR); Juyoung Lee, Gumi-si (KR)

Correspondence Address: BRINKS HOFER GILSON & LIONE, P.O. BOX 10395, CHICAGO, IL, 60610, US

(21) Appl. No.: 12/648,111

(22) Filed: Dec. 28, 2009

(30) Foreign Application Priority Data
May 15, 2009 (KR) 10-2009-0042413

(51) Int. Cl. G09G 3/36; G09G 5/02

(52) U.S. Cl. 345/691; 345/99; 345/88

(57) ABSTRACT

A liquid crystal display is disclosed. The liquid crystal display includes a timing controller outputting a pair of R digital video data, a pair of G digital video data, a pair of B digital video data, and a pair of clocks, a plurality of source driver integrated circuits (ICs), each of which receives the pair of each of R, G, and B digital video data and the pair of clocks from the timing controller to generate a positive analog data voltage and a negative analog data voltage, and a source printed circuit board (PCB) on which three pairs of data bus lines and a pair of clock lines are formed, the three pairs of data bus lines and the pair of clock lines connecting output terminals of the timing controller to input terminals of the source driver ICs.

This application claims the benefit of Korea Patent Application No. 10-2009-0042413 filed on May 15, 2009, the entire contents of which is incorporated herein by reference for all purposes as if fully set forth herein.

### BACKGROUND

1. Field of the Disclosure

The disclosure relates to a liquid crystal display.

2. Discussion of the Related Art

Active matrix type liquid crystal displays display a moving picture using a thin film transistor (TFT) as a switching element. The active matrix type liquid crystal displays have been implemented in televisions as well as display devices in portable devices, such as office equipment and computers, because of the thin profile of an active matrix type liquid crystal displays. Accordingly, cathode ray tubes (CRT) are being rapidly replaced by active matrix type liquid crystal displays.

A liquid crystal display generally includes a liquid crystal display panel, a backlight unit providing light to the liquid crystal display panel, a data drive circuit supplying a data voltage to data lines of the liquid crystal display panel, a source printed circuit board (PCB) connected to the data drive circuit, and the like. The source PCB is connected to the side of the liquid crystal display panel. A large number of lines including data bus lines, clock lines, control signal bus lines, etc. are formed on the source PCB. Accordingly, it is difficult to reduce the size of the source PCB in the related art liquid crystal display. Hence, it is difficult to achieve the thin profile of the liquid crystal display and to reduce the production cost of the source PCB.

### SUMMARY

A liquid crystal display comprises a timing controller that outputs a pair of R digital video data, a pair of G digital video data, a pair of B digital video data, and a pair of clocks, the pair of each of R, G, and B digital video data including positive data and negative data, the pair of clocks including a positive clock and a negative clock, a plurality of source driver integrated circuits (ICs), each of which receives the pair of each of R, G, and B digital video data and the pair of clocks from the timing controller to generate a positive analog data voltage and a negative analog data voltage and supplies the positive and negative analog data voltages to data lines of a liquid crystal display panel, and a source printed circuit board (PCB) on which three pairs of data bus lines and a pair of clock lines are formed, the three pairs of data bus lines and the pair of clock lines connecting output terminals of the timing controller to input terminals of the source driver ICs.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram illustrating a liquid crystal display according to an embodiment of the invention;

FIG. 2 is a block diagram illustrating a source driver integrated circuit (IC);

FIG. 3 schematically illustrates a connection structure between a timing controller and source driver ICs;

FIG. 4 illustrates data bus lines, clock lines, and control signal bus lines on a source printed circuit board (PCB)

FIGS. 5 and 6 are waveform diagrams showing an example of mini LVDS data and mini LVDS clock.

### DETAILED DESCRIPTION OF THE EMBODIMENTS

A method of manufacturing a liquid crystal display according to an embodiment of the invention includes a process for cleansing substrates of a liquid crystal display panel, a process for patterning the substrates, a process for forming and rubbing alignment layers, a process for sealing the substrates and dropping liquid crystals, a process for mounting driving circuits, a module assembly process, and the like.

The substrate cleansing process is a process for removing polluted materials from the surfaces of upper and lower glass substrates of the liquid crystal display panel using a cleansing solution. The substrate patterning process includes a process for forming and patterning various thin film materials, such as signal lines including data lines and gate lines, thin film transistors (TFTs), and pixel electrodes, on the lower glass substrate and a process for forming and patterning various thin film materials, such as a black matrix, a color filter, and a common electrode, on the upper glass substrate. In the process for forming and rubbing the alignment layers, alignment layers are respectively coated on the upper and lower glass substrates, and then are rubbed using a rubbing cloth or are photo-alignment processed. After the above-described processes are performed, a pixel array is formed on the lower glass substrate of the liquid crystal display panel. The pixel array includes data lines receiving a video data voltage, gate lines that cross the data lines and sequentially receive a scan signal (i.e., a gate pulse), TFTs formed at each of crossings of the data lines and the gate lines, pixel electrodes of liquid crystal cells respectively connected to the TFTs, a storage capacitor, and the like. A shift register of a gate drive circuit generating the scan signal may be formed at the same time as the pixel array during the substrate patterning process. A black matrix, a color filter, and a common electrode are formed on the upper glass substrate of the liquid crystal display panel. The common electrode is formed on the upper glass substrate in a vertical electric field driving manner, such as a twisted nematic (TN) mode and a vertical alignment (VA) mode. The common electrode and the pixel electrode are formed on the lower glass substrate in a horizontal electric field driving manner, such as an in-plane switching (IPS) mode and a fringe field switching (FFS) mode. Polarizing plates are attached respectively to the upper and lower glass substrates, and protective films are attached respectively to the polarizing plates.

In the process for sealing the substrates and dropping the liquid crystals, in a vacuum chamber, a sealant is drawn on one of the upper and lower glass substrates, and the liquid crystals are dropped onto the other glass substrate. Supposing that the liquid crystals are dropped onto the lower glass substrate, an ultraviolet curable sealant is formed on the upper glass substrate in the vacuum chamber. The upper glass substrate on which the ultraviolet curable sealant is formed is reversed and is fixed on an upper stage, and the lower glass substrate onto which the liquid crystals are dropped is fixed on a lower stage. Hence, the upper and lower glass substrates are aligned. Subsequently, a pressure is applied to one of the upper and lower glass substrates in a state where a pressure of the vacuum chamber is adjusted to a predetermined vacuum pressure by driving a vacuum pump to seal the upper and lower glass substrates to each other. In this case, a cell gap of a liquid crystal layer between the upper and lower glass substrates is set at a greater value than a cell gap set in the design. Subsequently, nitrogen (N₂) is injected into the vacuum chamber to adjust the pressure of the vacuum chamber to an atmospheric pressure. Hence, the cell gap of the liquid crystal layer is set at the cell gap set in the design because of a difference between a pressure inside the sealed glass substrates and the pressure of the vacuum chamber. In the state where the cell gap is set at the design value, ultraviolet rays from an ultraviolet light source are irradiated onto the ultraviolet curable sealant through the upper glass substrate or the lower glass substrate to cure the ultraviolet curable sealant.

In the process for mounting the driving circuits, source driver integrated circuits (ICs) of a data drive circuit are connected to the data lines of the lower glass substrate through a chip on glass (COG) process or a tape automated bonding (TAB) process, and the source driver ICs are connected to a source printed circuit board (PCB) on which a timing controller is mounted. In the gate drive circuit, gate driver ICs of the gate drive circuit may be connected to the gate lines of the lower glass substrate through the TAB process, or the gate drive circuit may be directly formed on the lower glass substrate through a Gate In Panel (GIP) process at the same time as the pixel array. In the embodiment, because the timing controller is mounted on the source PCB, a control PCB on which the timing controller was mounted in the related art may be omitted.

In the module assembly process, a backlight unit and the liquid crystal display panel are assembled into a liquid crystal module using a case member, such as a support main, a bottom cover, and a top case.

The method of manufacturing the liquid crystal display according to the embodiment of the invention may further include an inspection process and a repair process.

The inspection process includes an inspection of the ICs, an inspection of the signal lines, such as the data lines and the gate lines, on the lower glass substrate, an electrical inspection for detecting whether the TFTs and the pixel electrodes are defective, an electrical inspection conducted after the process for sealing the substrates and dropping the liquid crystals is performed, an lighting inspection for detecting whether the liquid crystal module is defective by turning on the backlight unit of the liquid crystal module, and the like. The repair process is performed on the defective signal lines and the defective TFTs that are determined as a repairable defective through the inspection process.

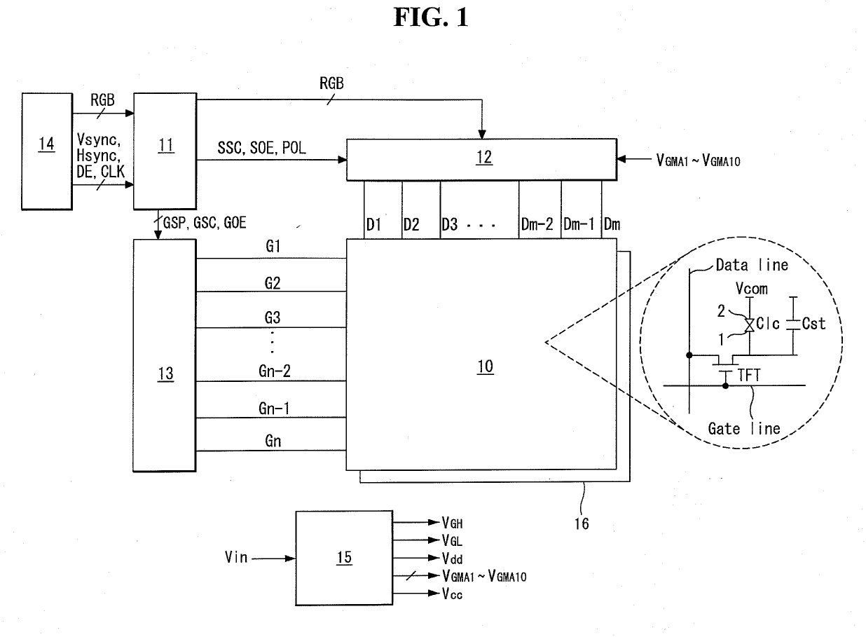

Reference will now be made in detail embodiments of the invention examples of which are illustrated in FIGS. 1 to 6.

As shown in FIG. 1, a liquid crystal display according to an embodiment of the invention includes a liquid crystal display panel 10, a backlight unit 16 underlying the liquid crystal display panel 10, a data drive circuit 12 connected to data lines D1 to Dm of the liquid crystal display panel 10, a gate drive circuit 13 connected to gate lines G1 to Gn of the liquid crystal display panel 10, a timing controller 11 for controlling the data drive circuit 12 and the gate drive circuit 13, and a DC to DC converter 15 generating a driving voltage of the liquid crystal display panel 10.

The liquid crystal display panel 10 includes an upper glass substrate and a lower glass substrate that are positioned opposite each other with a liquid crystal layer interposed between the upper glass substrate and the lower glass substrate. The liquid crystal display panel 10 includes a pixel array displaying video data. The pixel array of the lower glass substrate includes a TFT formed at each of crossings of the data lines D1 to Dm and the gate lines G1 to Gn and pixel electrodes 1 connected to the TFTs. The liquid crystal display panel 10 displays an image of the video data through a control of a transmitted amount of light provided by the backlight unit 16 by driving each of liquid crystal cells Clc of the pixel array by a difference between a data voltage applied to the pixel electrodes 1 through the TFTs and a common voltage Vcom applied to a common electrode 2 through the TFT.

A black matrix, a color filter, and the common electrode 2 are formed on the upper glass substrate of the liquid crystal display panel 10. The common electrode 2 is formed on the upper glass substrate in a vertical electric field driving manner, such as a TN mode and a VA mode. The common electrode 2 and the pixel electrode 1 are formed on the lower glass substrate in a horizontal electric field driving manner, such as an IPS mode and a FFS mode.

Polarizing plates are respectively attached to the upper and lower glass substrates of the liquid crystal display panel 10. Alignment layers for setting a pre-tilt angle of liquid crystals are respectively formed on the upper and lower glass substrates.

The liquid crystal display panel 10 applicable to the embodiment of the invention may be implemented in any liquid crystal mode as well as the TN, VA, IPS, and FFS modes. The liquid crystal display according to the embodiment of the invention may be implemented in any type liquid crystal display including a backlit liquid crystal display, a transflective liquid crystal display, and a reflective liquid crystal display. A backlight unit is necessary in the backlit liquid crystal display and the transflective liquid crystal display. The backlight unit 16 may be implemented as a direct type backlight unit or an edge type backlight unit. In the direct type backlight unit, a plurality of optical sheets and a diffusion plate are stacked under the liquid crystal display panel 10, and a plurality of light sources are positioned under the diffusion plate. In the edge type backlight unit, a plurality of light sources are positioned opposite the side of a light guide plate, and a plurality of optical sheets are positioned between the liquid crystal display panel 10 and the light guide plate. The light source of the backlight unit may use one or at least two of a hot cathode fluorescent lamp (HCFL), a cold cathode fluorescent lamp (CCFL), an external electrode fluorescent lamp (EEFL), and a light emitting diode (LED).

The data drive circuit 12 includes a plurality of source driver ICs. Each of the source driver ICs samples and latches R, G, and B digital video data according to a pair of each of R, G, and B data of mini low voltage differential signaling (LVDS) interface standard received from the timing controller 11 and mini LVDS clock received from the timing controller 11 to convert the latched R, G, and B digital video data into parallel data. Each of the source driver ICs converts the deserialized digital video data into a positive or negative analog video data voltage, to which the liquid crystal cells Clc will be charged, in response to a polarity control signal POL using positive or negative gamma reference voltages VGMA1 to VGMA10 from the DC to DC converter 15 and then supplies the positive/negative analog video data voltage to the data lines D1 to Dm in response to a source output enable signal SOE from the timing controller 11. The source driver ICs may be connected to the data lines D1 to Dm through a COG process or a TAB process.

The gate drive circuit 13 includes a plurality of gate driver ICs. Each of the gate driver ICs includes a shift register sequentially shifting a gate driving voltage in response to a gate control signal from the timing controller 11 to sequentially supply a gate pulse (i.e., a scan pulse) to the gate lines G1 to Gn. The gate driver ICs may be connected to the gate lines G1 to Gn of the lower glass substrate through the TAB process or may be directly formed on the lower glass substrate through a GIP process.

The timing controller 11 receives the R, G, and B digital video data and timing signals, such as a vertical sync signal Vsync, a horizontal sync signal Hsync, a data enable signal DE, and a dot clock CLK, from a system board 14 through an interface receiving circuit, such as a LVDS interface and a transition minimized differential signaling (TMDS) interface. The timing controller 11 simultaneously transfers a pair of R data, a pair of G data, and a pair of B data to the source driver ICs in a mini LVDS interface manner, so as to reduce a swing width of each of electromagnetic interference (EMI) and the data voltage on a data transfer path. The timing controller 11 generates a data control signal for controlling operation timing of the source driver ICs and a gate control signal for controlling operation timing of the gate driver ICs using the timing signals Vsync, Hsync, DE, and CLK. The timing controller 11 may multiply a frequency of each of the data control signal and the gate control signal based on a frame frequency of (60×i) Hz (where “i” is a positive integer), so that digital video data input at a frame frequency of 60 Hz can be reproduced in the pixel array of the liquid crystal display panel 10 at the frame frequency of (60×i) Hz.

The data control signal includes a source output enable signal SOE, a polarity control signal POL, and the like. If a signal transfer manner between the timing controller 11 and the data drive circuit 12 is the mini LVDS interface, a source start pulse and a source sampling clock, that were used in an existing transistor-to-transistor (TTL) interface, may be omitted. The source output enable signal SOE controls output timing of the data drive circuit 12. When a polarity of the data voltage supplied to the data lines D1 to Dm is inverted, each of the source driver ICs of the data drive circuit 12 supplies a charge share voltage or the common voltage Vcom to the data lines D1 to Dm in response to a pulse of the source output enable signal SOE and supplies the data voltage to the data lines D1 to Dm during a low logic period of the source output enable signal SOE. The charge share voltage is an average voltage of the neighboring data lines to which the data voltages with opposite polarities are supplied. The polarity control signal POL inverts a polarity of the data voltage output from the data drive circuit 12 every N horizontal periods, where N is a positive integer.

The gate control signal includes a gate start pulse GSP, a gate shift clock GSC, a gate output enable signal GOE, and the like. The gate start pulse GSP controls timing of a first gate pulse. The gate shift clock GSC is a clock for shifting the gate start pulse GSP. The gate output enable signal GOE controls output timing of the gate drive circuit 13.

The system board 14 transfers the timing signals, such as the vertical sync signal Vsync, the horizontal sync signal Hsync, the data enable signal DE, and the dot clock CLK, together with the R, G, and B digital video data received from a broadcast receiving circuit or an external video source to the timing controller 11 through a LVDS interface transmitting circuit or a TMDS interface transmitting circuit. The system board 14 includes a graphic processing circuit, such as a scaler, and a power circuit. The graphic processing circuit interpolates a resolution of the R, G, and B digital video data in conformity with a resolution of the liquid crystal display panel 10 and performs a signal interpolation processing on the R, G, and B digital video data. The power circuit produces a voltage Vin to be supplied to the DC to DC converter 15.

The DC to DC converter 15 adjusts the voltage Vin received from the power circuit of the system board 14 to generate a driving voltage of the liquid crystal display panel 10. The driving voltage of the liquid crystal display panel 10 includes a high potential source voltage Vdd of 15V-20V, a logic source voltage Vcc of about 3.3V, a agate high voltage VGH equal to or greater than 15V, a gate low voltage VGL equal to or less than −3V, the common voltage Vcom of 7V-8V, the positive or negative gamma reference voltages VGMA1 to VGMA10, a core power voltage of 1.2V-1.8V, etc. The high potential source voltage Vdd is a maximum data voltage to which the liquid crystal cells Clc of the liquid crystal display panel 10 will be charged. The logic source voltage Vcc is a source voltage of a digital logic element, such as the timing controller 11, the source driver ICs, and the gate driver ICs. The gate high voltage VGH is a high logic voltage of a gate pulse that is set to a value equal to or greater than a threshold voltage of the TFTs formed in the pixel array. The gate low voltage VGL is a low logic voltage of the gate pulse that is set to a value less than the threshold voltage of the TFTs formed in the pixel array. The gate high voltage VGH and the gate low voltage VGL are supplied to the gate drive circuit 13. The common voltage Vcom is supplied to the common electrode 2 of the liquid crystal cells Clc. The source driver ICs may supply the common voltage Vcom as the charge share voltage to the data lines D1 to Dm during a high logic period of the source output enable signal SOE. In a storage on common manner, a storage electrode of a storage capacitor Cst may be formed on the lower glass substrate of the liquid crystal display panel 10, so that the storage electrode overlaps the pixel electrode 1 with an insulating layer interposed between the storage electrode and the pixel electrode 1. In the storage on common manner, the common voltage Vcom may be supplied to the storage electrode. The core power voltage is a logic voltage for producing the data voltage in the mini LVDS interface manner.

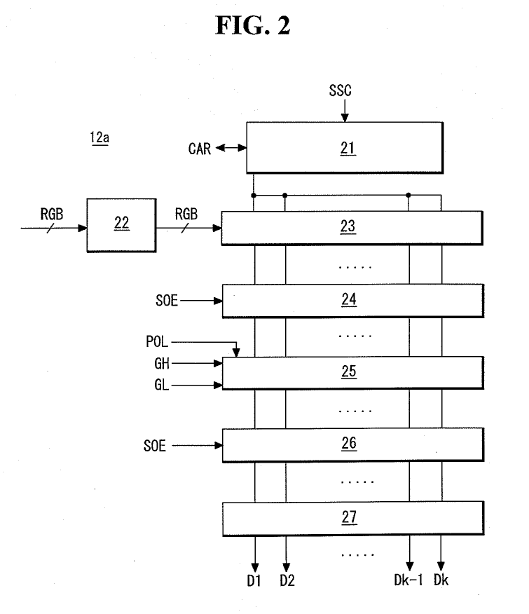

FIG. 2 is a block diagram illustrating the source driver IC.

As shown in FIG. 2, each of source driver ICs 12a includes a shift register 21, a data receiving unit 22, a first latch array 23, a second latch array 24, a digital-to-analog converter (DAC) 25, a charge share circuit 26, and an output circuit 27.

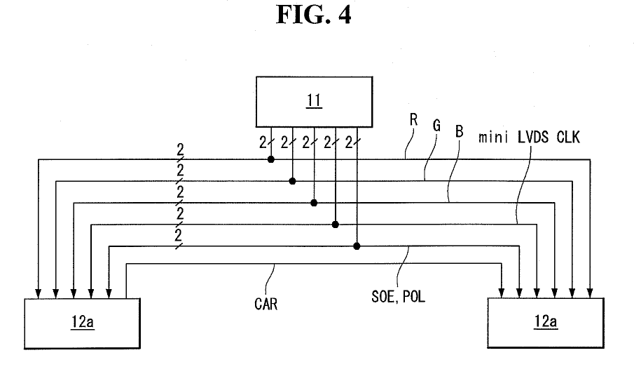

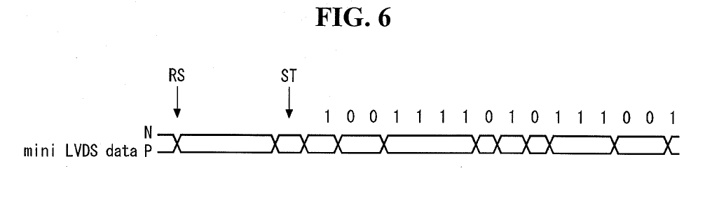

The data receiving unit 22 receives mini LVDS data and mini LVDS clock from the timing controller 11 to restore R, G, and B digital video data of a TTL level using a mini LVDS interface restoring method and to generate a source sampling clock SSC of a TTL level. The mini LVDS data, as shown in FIGS. 4 to 6, includes a pair of R data (i.e., a differential signal) including positive data and negative data, a pair of G data (i.e., a differential signal) including positive data and negative data, and a pair of B data (i.e., a differential signal) including positive data and negative data. The mini LVDS clock includes a pair of clocks (i.e., a differential signal) including positive clock and negative clock. For example, the data receiving unit 22 outputs a logic value “1” from the mini LVDS data received from the timing controller 11 when a logic level of positive data P is a high level as shown in FIG. 6. Further, the data receiving unit 22 outputs a logic value “0” from the mini LVDS data received from the timing controller 11 when a logic level of the positive data P is a low level as shown in FIG. 6. Hence, the data receiving unit 22 restores data to supplies the restored data to the first latch array 23.

The shift register 21 shifts the source sampling clock SSC to generate a sampling clock. When the first latch array 23 receives data exceeding the number of latch operations in the first latch array 23, the shift register 21 generates a carry signal CAR. The first latch array 23 samples the R, G, and B digital video data restored by the data receiving unit 22 in response to the sampling clock sequentially received from the shift register 21, latches the sampled R, G, and B digital video data corresponding to each horizontal line, and simultaneously outputs the R, G, and B latched digital video data corresponding to each horizontal line.

The second latch array 24 latches the R, G, and B digital video data corresponding to each horizontal line received from the first latch array 23. Then, the second latch array 24 and the second latch arrays 24 of the other source driver ICs 12a simultaneously output the latched R, G, and B digital video data during a low logic period of the source output enable signal SOE.

The DAC 25 includes a P-decoder receiving a positive gamma compensation voltage GH, an N-decoder receiving a negative gamma compensation voltage GL, and a multiplexer selecting an output of the P-decoder and an output of the N-decoder in response to the polarity control signal POL. The P-decoder decodes the R, G, and B digital video data received from the second latch array 24 to output the positive gamma compensation voltage GH corresponding to a gray level of the R, G, and B digital video data. The N-decoder decodes the R, G, and B digital video data received from the second latch array 24 to output the negative gamma compensation voltage GL corresponding to a gray level of the R, G, and B digital video data. The multiplexer selects the positive gamma compensation voltage GH and the negative gamma compensation voltage GL in response to the polarity control signal POL.

The charge share circuit 26 shorts neighboring data output channels to output an average value of the neighboring data voltages as the charge share voltage during a high logic period of the source output enable signal SOE. Otherwise, during the high logic period of the source output enable signal SOE, the charge share circuit 26 outputs the common voltage Vcom to reduce a sharp change in the positive data voltage and the negative data voltage. The output circuit 27 reduces a signal attenuation of the positive/negative data voltage supplied to the data lines D1 to Dk (where k is a positive integer smaller than m) using a buffer.

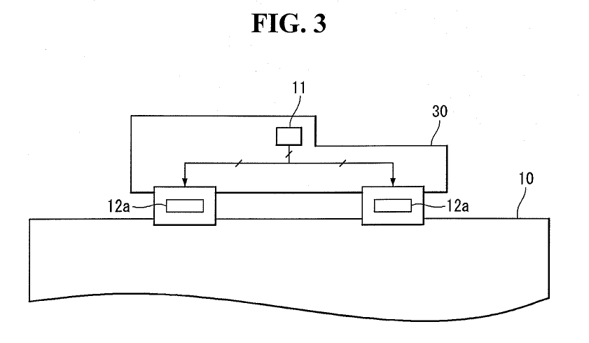

FIGS. 3 and 4 schematically illustrate a connection structure between the timing controller 11 and the source driver ICs 12a.

As shown in FIGS. 3 and 4, the timing controller 11 is mounted on a source PCB 30, and each of the source driver ICs 12a is mounted on a source tape carrier package (TCP). Output terminals of the source PCB 30 are connected to input terminals of the source TCPs. Output terminals of the source TCPs are attached to the lower glass substrate of the liquid crystal display panel 10 using an anisotropic conductive film (ACF) and are connected to the data lines D1 to Dm.

The timing controller 11 does not divide R, G, and B digital video data of TTL level (about 3.3V) received from the system board 14 into odd digital video data and even digital video data. The timing controller 11 converts each of the R, G, and B digital video data of TTL level into the mini LVDS data having a swing width of about 300 mV-about 600 mV to transfer the mini LVDS data together with the mini LVDS clock to the source driver ICs 12a. A frequency of the mini LVDS clock transferred to the source driver ICs 12a is about four times greater than a frequency of the dot clock input to the timing controller 11.

If the timing controller 11 divides each of the R, G, and B digital video data into odd digital video data and even digital video data, the mini LVDS data transferred to each of the source driver ICs 12a includes a pair of R odd data, a pair of R even data, a pair of G odd data, a pair of G even data, a pair of B odd data, and a pair of B even data. In this case, at least 12 data bus lines have to be formed on the source PCB 30. On the contrary, in the embodiment of the invention, because each of the R, G, and B digital video data is not divided into odd digital video data and even digital video data, only 6 data lines (i.e., three pairs of data lines) on the source PCB 30 are sufficient to transfer a pair of R data, a pair of G data, and a pair of B data. As a result, the production cost of the source PCB 30 can be reduced by reducing the size of the source PCB 30.

The mini LVDS data and mini LVDS clock output from the timing controller 11 are transferred to each of the source driver ICs 12a through the data bus lines and the clock lines shown in FIG. 4. The data bus lines are connected to data output terminals of the timing controller 11 and are connected to data input terminals of the source driver ICs 12a. The clock lines are connected to clock output terminals of the timing controller 11 and are connected to clock input terminals of the source driver ICs 12a. More specifically, the first pair of data bus lines transferring the pair of R digital video data are connected to first data output terminals of the timing controller 11 and are divided in a T-shaped form to be connected to first data input terminals of each of the source driver ICs 12a. The second pair of data bus lines transferring the pair of G digital video data are connected to second data output terminals of the timing controller 11 and are divided in a T-shaped form to be connected to second data input terminals of each of the source driver ICs 12a. The third pair of data bus lines transferring the pair of B digital video data are connected to third data output terminals of the timing controller 11 and are divided in a T-shaped form to be connected to third data input terminals of each of the source driver ICs 12a. The pair of clock lines are connected to clock output terminals of the timing controller 11 and are divided in a T-shaped form to be connected to clock input terminals of each of the source driver ICs 12a.

The data control signals SOE and POL for controlling the source driver ICs 12a are simultaneously transferred to each of the source driver ICs 12a through control signal bus lines. Each of the control signal bus lines is connected to a control signal output terminal of the timing controller 11 and is divided in a T-shaped form to be connected to a control signal input terminal of each of the source driver ICs 12a. The data bus lines, the clock lines, and the control signal bus lines are formed on the source PCB 30.

FIG. 4 shows only two source driver ICs 12a for the convenience of explanation, but two or more source driver ICs may be used in the liquid crystal display according to the embodiment of the invention.

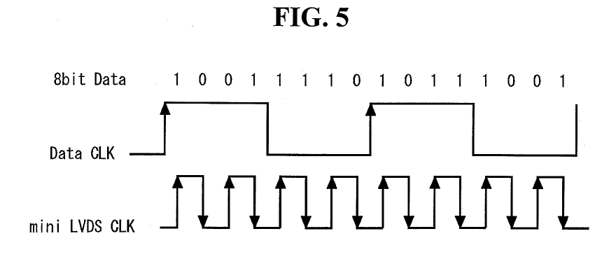

FIGS. 5 and 6 are waveform diagrams showing mini LVDS data and mini LVDS clock.

In FIGS. 5 and 6, “Data CLK” indicates a dot clock produced by the system board 14, and “mini LVDS CLK” indicates mini LVDS clock produced by the timing controller 11. The mini LVDS clock together with mini LVDS data are transferred to each of the source driver ICs 12a. Further, the mini LVDS data includes positive data P and negative data N including a reset waveform. The timing controller 11 converts each of R, G, and B digital video data and clock into positive data P and negative data N to transfer a pair of R data, a pair of G data, a pair of B data, and a pair of clocks each including the positive data P and the negative data N to each of the source driver ICs 12a through the pairs of data bus lines and the pairs of clock lines. Because each of the R, G, and B digital video data is not divided into odd digital video data and even digital video data by the timing controller 11, the R, G, and B digital video data is transferred to each of the source driver ICs through the three pairs of data bus lines. A first source driver IC 12a sampling first data recognizes a generation time point of a start pulse ST generated subsequent to a reset waveform RS as a start time point of a data sampling operation to start sampling data supplied subsequent to the state pulse ST.

As describe above, in the liquid crystal display according to the embodiment of the invention, because the R, G, and B digital video data, each of which is not divided into odd digital video data and even digital video data, is transferred to each of the source driver ICs through the three pairs of data bus lines, the size of the source PCB can be reduced. As a result, the thin profile liquid crystal display can be provided, and the production cost of the source PCB can be reduced.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A liquid crystal display comprising:
a timing controller that outputs a pair of R digital video data, a pair of G digital video data, a pair of B digital video data, and a pair of clocks, the pair of each of R, G, and B digital video data including positive data and negative data, the pair of clocks including a positive clock and a negative clock;
a plurality of source driver integrated circuits (ICs), each of which receives the pair of each of R, G, and B digital video data and the pair of clocks from the timing controller to generate a positive analog data voltage and a negative analog data voltage and supplies the positive and negative analog data voltages to data lines of a liquid crystal display panel; and
a source printed circuit board (PCB) having three pairs of data bus lines and a pair of clock lines, the three pairs of data bus lines and the pair of clock lines connecting output terminals of the timing controller to input terminals of the source driver ICs.

2. The liquid crystal display of claim 1, wherein the positive data and the negative data of the pair of each of R, G, and B digital video data are simultaneously transferred to the source driver ICs through the three pairs of data bus lines,
wherein the positive clock and the negative clock of the pair of clocks are simultaneously transferred to the source driver ICs through the pair of clock lines.

3. The liquid crystal display of claim 2, wherein the pair of each of R, G, and B digital video has a swing width of about 300 mV-about 600 mV.

4. The liquid crystal display of claim 1, wherein a transfer frequency of the pair of each of R, G, and B digital video output from the timing controller is greater than an input frequency of R, G, and B digital video input to the timing controller.

5. The liquid crystal display of claim 2, wherein the pair of data bus lines transferring the pair of R digital video data are connected to first data output terminals of the timing controller and are divided in a T-shaped form to be connected to first data input terminals of each of the source driver ICs,
wherein the pair of data bus lines transferring the pair of G digital video data are connected to second data output terminals of the timing controller and are divided in a T-shaped form to be connected to second data input terminals of each of the source driver ICs,
wherein the pair of data bus lines transferring the pair of B digital video data are connected to third data output terminals of the timing controller and are divided in a T-shaped form to be connected to third data input terminals of each of the source driver ICs,
wherein the pair of clock lines are connected to clock output terminals of the timing controller and are divided in a T-shaped form to be connected to clock input terminals of each of the source driver ICs.

6. The liquid crystal display of claim 5, wherein the timing controller generates a source output enable signal for controlling output timing of each of the source driver ICs and a polarity control signal for controlling a polarity of the data voltages output from the source driver ICs.

7. The liquid crystal display of claim 6, wherein the source PCB includes control signal bus lines used to simultaneously transfer the source output enable signal and the polarity control signal to the source driver ICs.

8. The liquid crystal display of claim 7, wherein each of the control signal bus lines is connected to a control signal output terminal of the timing controller and is divided in a T-shaped form to be connected to a control signal input terminal of each of the source driver ICs.
